(19) United States
(12) Patent Application Publication
(10) Pub. No.: US 2020/0379211 A1
(43) Pub. Date: Dec. 3, 2020

(54) AUTO FOCUSING LENS ASSEMBLY

(71) Applicant: AAC Optics Solutions Pte. Ltd., Singapore city (SG)

(72) Inventors: Linzhen Li, Shenzhen (CN); Jiliang Lu, Shenzhen (CN); Gang Li, Shenzhen (CN); Jin Zhang, Shenzhen (CN)

(21) Appl. No.: 16/993,302

(22) Filed: Aug. 14, 2020

Related U.S. Application Data
(63) Continuation of application No. PCT/CN2019/089721, filed on Jun. 1, 2019.

(51) Int. Cl. G02B 7/09

(52) U.S. Cl. CPC G02B 7/09

(57) ABSTRACT

Provided is an auto focusing lens assembly, including: a lens; a first base; a second base; and a pair of restoring structures. The first base is mounted to the second base and slidable in a direction parallel to an optical axis of the lens. The first base includes a first bottom plate and a first side arm. The second base includes a second bottom plate, and a second side arm. The first side arm includes: first and second plate bodies. Each restoring structure includes: a magnet assembly, a guiding structure provided between the first plate body and the second side arm, and an elastic member provided between the first side arm and the second side arm in the direction parallel to the optical axis. The auto focusing lens assembly provided by the present invention can achieve a compact structure, a miniaturization design and the like advantages.

### TECHNICAL FIELD

The present invention relates to the field of lens optical image stabilization and auto focusing, and more particularly, to an auto focusing lens assembly.

### BACKGROUND

In recent years, portable terminals such as smartphones and tablet computers have been equipped with a high-performance lens module. Such high-performance lens module generally has an auto focusing function and an optical image stabilization (OIS) function.

The auto focusing function of the existing camera lens module is implemented by a voice coil motor driving a lens to move to achieve auto focusing and then driving the lens again to restore to an initial position. However, the lens having such a structure is relatively complicated, and thus it is difficult to achieve miniaturization of the lens module.

Therefore, it is needed to provide a new camera lens module to solve the problems described above.

### SUMMARY

The present invention aims to provide an auto focusing lens assembly having a simple and compact structure that can achieve a miniaturization design.

The purpose of the present invention is achieved by the following technical solutions.

An auto focusing lens assembly is provided, including: a lens; a first base; a second base; and a pair of restoring structures. The lens is located in the first base, and the first base is mounted to the second base and slidable in a direction parallel to an optical axis of the lens; the first base includes: a first bottom plate, and a first side arm extending from the first bottom plate while being bent and respectively located at two sides of the lens; the second base includes a second bottom plate, and a second side arm extending from the second bottom plate while being bent and respectively located outside the first side arm; the first side arm includes: a first plate body opposite to the second side arm, and a second plate body extending from an end of the first plate body facing away from the first bottom plate while being bent and located above the second side arm; one of the pair of restoring structures is provided at one of the two sides of the lens, and the other one of the pair of restoring structures is provided at the other one of the two sides of the lens; each restoring structure of the pair of restoring structures includes: at least one magnet assembly provided between the second side arm and the second plate body, at least one guiding structure provided between the first plate body and the second side arm, and an elastic member provided between the first side arm and the second side arm in the direction parallel to the optical axis.

As an improvement, a projection of the at least one magnet assembly in a direction perpendicular to the optical axis is located on the elastic member.

As an improvement, the at least one guiding structure is located between the elastic member and the at least one magnet assembly in a direction perpendicular to the optical axis of the lens.

As an improvement, the first side arm further includes a third plate body extending from an end of the first plate body facing away from an object side of the lens in the direction of the optical axis; and the first plate body, the second plate body and the third plate body form a recess for receiving the second side arm.

As an improvement, the second side arm includes a first connecting portion connected to the second bottom plate, a second connecting portion spaced apart from and opposite to the first connecting portion, and a third connecting portion connected to a side of the first connecting portion facing away from the third plate body and a side of the second connecting portion facing away from the third plate body; and the elastic member includes an end connected to the third plate body, and another end connected to the third connecting portion.

As an improvement, the at least one magnet assembly includes two magnet assemblies provided between the second side arm and the second plate body, and the two magnet assemblies are spaced apart from each other.

As an improvement, each of the two magnet assemblies includes: a first magnet located at a side of the second side arm facing towards the second plate body, and a second magnet directly opposite to the first magnet and provided at a side of the second plate body facing towards the second side arm.

As an improvement, a first recess is provided at the side of the second side arm facing towards the second plate body, and the first magnet is embedded into the first recess; and a second recess is provided at the side of the second plate body facing towards the second side arm, and the second magnet is embedded into the second recess.

As an improvement, the at least one guiding structure includes two guiding structures provided between the second side arm and the first plate body, and the two guiding structures are spaced apart from each other.

As an improvement, each of the two guiding structures includes: a first guiding groove formed by recessing from a surface of the first plate body facing towards the second side arm in the direction of the optical axis, a bearing portion provided at a surface of the second side arm facing towards the first plate body and configured to form a guiding channel in cooperation with the first guiding groove, and a ball provided between the first guiding groove and the bearing portion.

As an improvement, the auto focusing lens assembly further includes a memory alloy wire for auto focusing of the lens. The memory alloy wire includes an end fixed to the first base, and another end fixed to the second base; and a projection of the elastic member in a direction perpendicular to the optical axis is located on the memory alloy line.

Compared with the related art, in the embodiments of the present invention, the elastic member cooperates with the magnet assembly to pull the deviated first base, in such a manner that the first base is restored to the initial position under guiding of the guiding structure. Compared with a traditional method using a voice coil motor, the design with the restoring structure is simple in structure. Moreover, the magnet assembly is provided between the second side arm and the second plate body, the guiding structure is provided between the first plate body and the second side arm, and the elastic member is provided between the first side arm and the second side arm in the direction parallel to the optical axis. In this way, an overall structure formed by the restoring structure, the first base, the second base and the lens is very compact, so that an overall dimension of the lens assembly can be made small, thereby achieving a miniaturization design.

### BRIEF DESCRIPTION OF DRAWINGS

Many aspects of the exemplary embodiment can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

FIG. 1 is a schematic diagram of a structure of an auto focusing lens assembly according to an embodiment of the present invention;

FIG. 2 is a schematic diagram of a structure of a lens and a first base;

FIG. 3 is a schematic diagram of a structure of a lens and a first base from another perspective;

FIG. 4 is a schematic explosive view of an auto focusing lens assembly according to an embodiment of the present invention;

FIG. 5 is a schematic diagram illustrating cooperation of a first base and a second base;

FIG. 6 is a schematic diagram illustrating cooperation of a first base and a second base from another perspective;

FIG. 7 is a schematic diagram of a structure of a first base and a second base;

FIG. 8 is a schematic diagram of a structure of a first base; and

FIG. 9 is a schematic diagram of a structure of a second base.

### DESCRIPTION OF EMBODIMENTS

The present invention will be further described in the following with reference to the accompany drawings and embodiments.

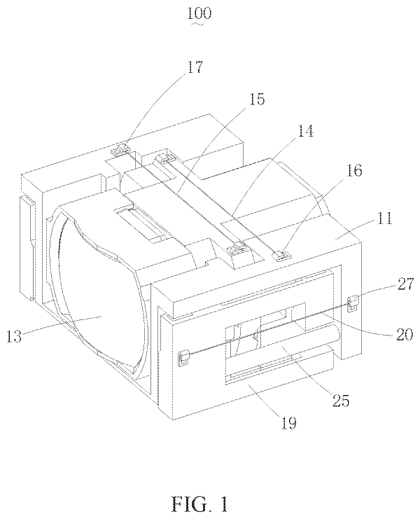

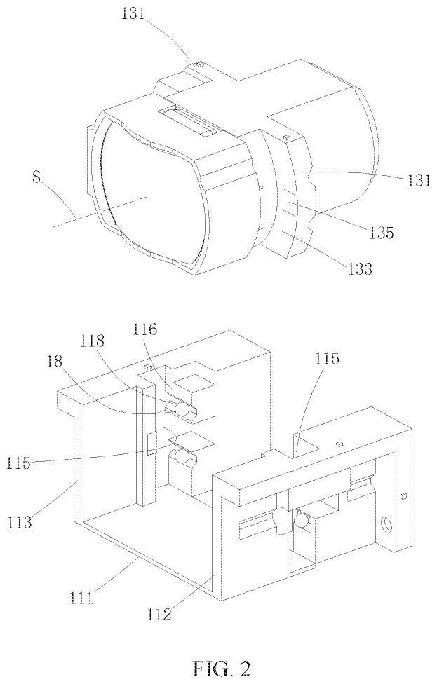

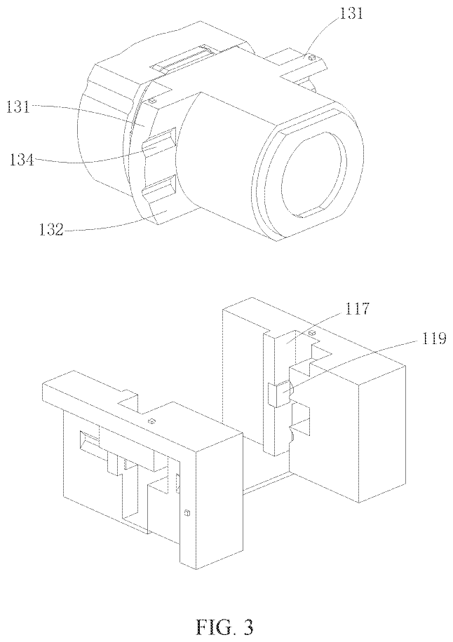

With reference to FIG. 1 to FIG. 3, embodiments of the present invention provide a lens assembly 100, which includes a first base 11, a lens 13, a first memory alloy wire 14 and a second memory alloy wire 15. The lens 13 is located in the first base 11. The first base 11 includes a first bottom plate 111, a first side plate 112 extending from the first bottom plate 111 while being bent and located at one side of the lens 13, and a second side plate 113 extending from the first bottom plate 111 while being bent and located at the other side of the lens 13. The first memory alloy wire 14 and the second memory alloy wire 15 are both suspended above the lens 13. The first memory alloy wire 14 includes one end connected to a side of the first side plate 112 facing away from the first bottom plate 111, and another end connected to a side of the lens 13 close to the second side plate 112. The second memory alloy wire 15 includes one end connected to a side of the second side plate 113 facing away from the first bottom plate 111, and another end connected to the side of the lens 13 close to the first side plate 112. Both the first memory alloy wire 14 and the second memory alloy wire 15 are perpendicular to an optical axis of the lens 13.

When there is no deviation for the lens 13, the lens 13 is located at an initial position of the first base 12, and the first memory alloy wire 14 and the second memory alloy wire 15 are in a loose state. When the lens 13 is deviated towards the first side plate 112 or the second side plate 113, for example, when the lens 13 is deviated towards the second side plate 113, the first memory alloy wire 14 is elongated. When a current is applied to the first memory alloy wire 14, so that a temperature thereof increases, the first memory alloy wire 14 is shortened due to its own physical characteristics, thereby pulling the lens 13 back to the original position. In this way, optical image stabilization of the lens 13 can be achieved, thereby improving an imaging quality of the lens 13.

Compared with the related art, in this embodiment, the first memory alloy wire 14 and the second memory alloy wire 15 are energized to deform, so as to drive the lens 13 to move back and forth between the first side plate 112 and second side plate 113 to achieve optical image stabilization. Therefore, there is no need for a traditional driving method using an interaction between the voice coil and the magnetic steel, and there is no problem of magnetic field interference, and thus stability thereof is high. Moreover, such driving method is simple in structure and convenient in assembling, has no need for an additional Hall element, and has high usage reliability in a special environment. Moreover, compared with the existing image stabilization structure using a magnet cooperating with an image stabilization coil, the use of the first memory alloy wire 14 and the second memory alloy wire 15 according to the present embodiment can significantly reduce a weight and a cost thereof. In addition, compared with the existing image stabilization structure using a magnet cooperating with an image stabilization coil, the use of the first memory alloy wire 14 and the second memory alloy wire 15 according to the present embodiment can pull the lens 13 as long as a small amount of current is applied to the first memory alloy wire 14 and the second memory alloy wire 15, thereby achieving an optical image stabilization effect while effectively reducing power consumption thereof.

It should be understood that the first memory alloy wire 14 and the second memory alloy wire 15 are not limited to being parallel to and spaced apart from each other. For example, it is also possible that the first memory alloy wire 14 and the second memory alloy wire 15 are arranged coaxially (the first memory alloy wire 14 includes one end connected to the first side plate 112, an another end connected to a middle portion of the lens 13; and similarly, the second memory alloy wire 15 includes one end connected to the second side plate 113, and another end connected to a middle portion of the lens 13), as long as the first memory alloy wire 14 and the second memory alloy wire 15 can pull the lens 13 to move back and forth between the first side plate 112 and the second side plate 113 to achieve optical image stabilization. Further, one end of the first memory alloy 13 is not limited to being connected to the side of the first side plate 112 facing away from the first bottom plate 111, but can be connected to any portion of the first side plate 112, and the other end is connected to the lens 13, as long as the first memory alloy 13 has a sufficient length for pulling the lens 13 to move between the first side plate 112 and the second side plate 113.

In an example, the first memory alloy wire 14 and the second memory alloy wire 15 are each made of a nickel-titanium alloy material. By controlling an amount of electricity flowing in the first memory alloy wire 14 and the second memory alloy wire 15, heat generated in the first memory alloy wire 14 and the second memory alloy wire 15 can be controlled, thereby controlling shortening amounts of the first memory alloy wire 14 and the second memory alloy wire 15.

It should be noted that due to respective physical characteristics of the first memory alloy wire 14 and the second memory alloy wire 15, when the first memory alloy wire 14 and the second memory alloy wire 15 are shortened, respective resistance values will change. Therefore, it is possible to detect whether the lens is deviated by providing a detection circuit and a chip. In an example, the detection circuit detects a magnitude of a current flowing through the first memory alloy wire 14 and the second memory alloy wire 15 and transmits a signal to the chip. The chip may calculate the respective resistance values of the first memory alloy wire 14 and the second memory alloy wire 15 based on the detected current signal. Then, the chip obtains respective length values of the first memory alloy wire 14 and the second memory alloy wire 15 based on a corresponding relation between the respective resistance values and the respective lengths of the first memory alloy wire 14 and the second memory alloy wire 15, thereby determining whether the first memory alloy wire 14 and the second memory alloy wire 15 are shortened and how much shortened amounts are. In this way, the amount of current flowing into the first memory alloy wire 14 and the second memory alloy wire 15 can be controlled, so as to pull the lens 13 back to the initial position more accurately.

As an improvement of this embodiment, the lens assembly 100 further includes two first connecting terminals 16 and two second connecting terminals 17. One of the two first connecting terminals 16 is connected to a side of the first side plate 112 facing away from the first bottom plate 111, and the other one of two first connecting terminals is connected to a side of the lens 13 close to the second side plate 113. Two ends of the first memory alloy wire 14 are respectively connected to the two first connecting terminals 16. One of the two second connecting terminals 17 is connected to a side of the second side plate 113 facing away from the first bottom plate 111, and the other one of the two second connecting terminals 17 is connected to a side of the lens 13 close to the first side plate 112. Two ends of the second memory alloy wire 15 are respectively connected to the two second connecting terminals 17. By providing the first connecting terminal 16 and the second connecting terminal 17, on the one hand, it is convenient to connect the first memory alloy wire 14 with the first side plate 112 and to connect the second memory alloy wire 15 with the second side plate 113, and on the other hand, it is convenient to connect the first memory alloy wire 14 and the second memory alloy wire 15 with external power wires.

It is understood that the lens assembly 100 may not be provided with the first connecting terminal 16 and the second connecting terminal 17, and the first memory alloy wire 14 and the second memory alloy wire 15 may be fixed between the lens 13 and the first side plate 112 and the second side plate 113 by other connection ways.

As an improvement of this embodiment, the lens assembly 10 further includes a first ball 18 provided between the lens 13 and the first base 11. By providing the first ball 18, a frictional force generated when the lens 13 is moving between the first side plate 112 and the second side plate 113 can be reduced, so that movement of the lens 13 is smoother, and the optical image stabilization response is more sensitive.

As an improvement of this embodiment, the first side plate 112 and the second side plate 113 are each provided with a first recess 115, and two opposite sides of the lens 13 are each provided with a first protrusion 131, and the two first protrusions 131 protrude oppositely and are embedded into the two first recesses 115, respectively. Each first recess 115 includes a first side surface 116 and a second side surface 117 that are spaced apart from each other along a direction of the optical axis S. Each first protrusion 131 includes a first surface 132 opposite to the first side surface 116 and a second surface 133 opposite to the second side surface 117. The first side surface 116 is provided with a first guiding groove 118, and the first surface 132 is provided with a second guiding groove 134 directly facing the first guiding groove 118. At least one first ball 18 is embedded between the first guiding groove 118 and the second guiding groove 134. The first guiding groove 118 is perpendicular to the direction of the optical axis S and is parallel to the first bottom plate 111.

As an improvement of this embodiment, two first guiding grooves 118 are provided, and the two first guiding grooves 118 are parallel to and spaced apart from each other in a direction perpendicular to the first bottom plate 111. Two second guiding grooves 134 are provided, and the two second guiding grooves 134 are parallel to and spaced apart from each other in the direction perpendicular to the first bottom plate 111. The two second guiding grooves 134 directly face the two first guiding grooves 118, respectively. At least one first ball 18 is embedded between each first guiding groove 118 and the corresponding second guiding groove before groove 134. By providing the two first guiding grooves 118 and the corresponding two second guiding grooves 134, an operation of the lens 13 can be more stable.

As an improvement of this embodiment, a first magnet 135 is provided at a side of the first protrusion 131 where the second surface 133 is located, and a second magnet 119 opposite to the first magnet 135 for achieving magnetic attraction with the first magnet 135 is provided at the second side surface 117 of the first recess 115. The first magnet 135 and the second magnet 119 are mainly used to cooperate with the first memory alloy wire 14 or the second memory alloy wire 15 to restore the deviated lens 13 to the initial position. Initially, there is no deviation for the lens 13, and the first magnet 135 directly faces the second magnet 119. When the lens 13 is deviated, for example, when the lens 13 is deviated towards the second side plate 113, the first memory alloy wire 14 is elongated, and the first magnet 135 is misaligned with the second magnet 119. Then, the first memory alloy wire 14 is energized to be shortened, and cooperate with a mutual magnetic force between the first magnet 135 and the second magnet 119 to restore the lens 13 to the initial position.

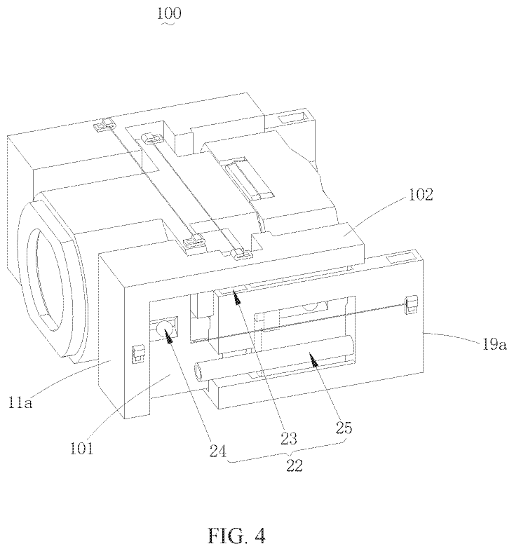

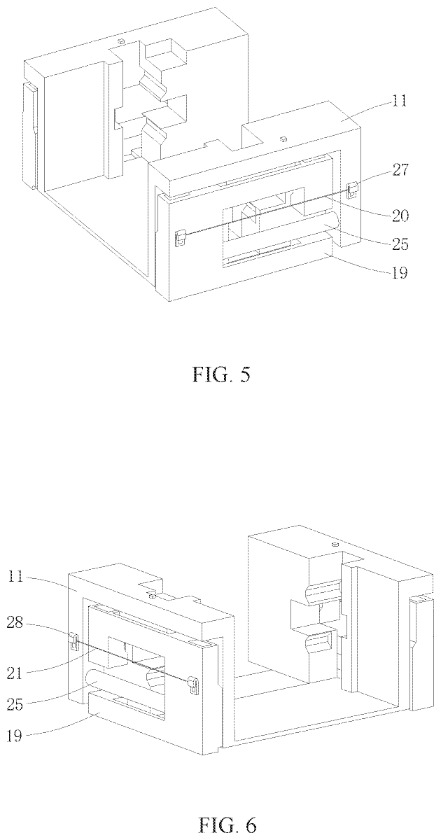

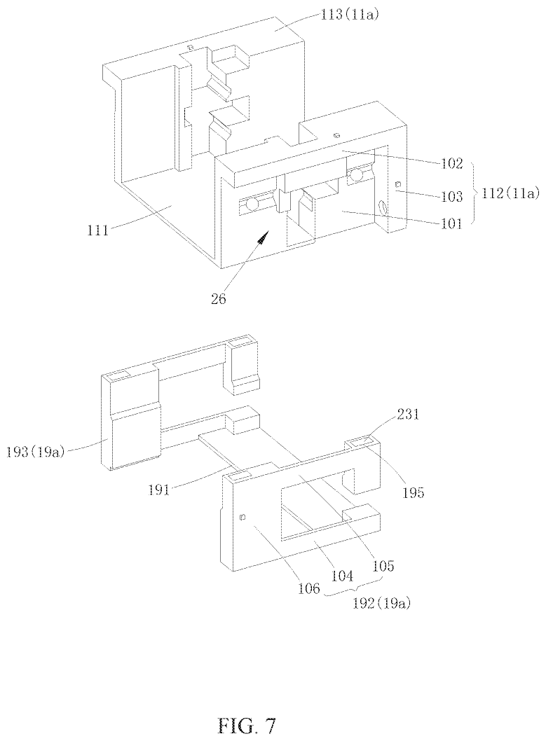

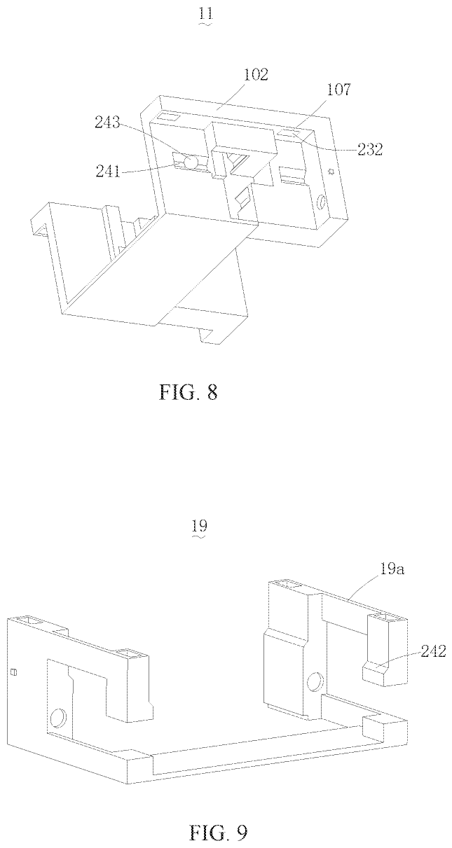

With reference to FIG. 1, and FIG. 4 to FIG. 9, as an improvement of this embodiment, the lens assembly 100 further includes a second base 19, a third memory alloy wire 20, a fourth memory alloy wire 21, and a pair of restoring structures 22. The first base 11 is mounted to the second base 19 and slidable in a direction parallel to the optical axis S of the lens 13. The second base 19 includes a second bottom plate 191, a third side plate 192 extending from the second bottom plate 191 while being bent and located outside the first side plate 112, and a fourth side plate 193 extending from the second bottom plate 191 while being bent and located outside the second side plate 113. The third memory alloy wire 20 extends in the direction parallel to the optical axis S and includes two ends respectively connected to the first side plate 112 and the third side plate 192. The fourth memory alloy wire 21 extends in the direction of the optical axis S and includes two ends respectively connected to the second side plate 113 and the fourth side plate 193. One restoring structure 22 is provided between the first side plate 112 and the third side plate 192 and another restoring structure 22 is provided between the second side plate 113 and the fourth side plate 193, and the restoring structures 22 are configured to restore the deviated first base 11 and lens 13 to the initial position.

Initially, the first base 11 is located at an initial position of the second base 19, that is, the lens 13 is located at a preset initial position. When focusing, a current is applied to the third memory alloy wire 20 and the fourth memory alloy wire 21, the third memory alloy wire 20 and the fourth memory alloy wire 21 are heated, and respective lengths thereof are shortened, thereby pulling the first base 11 to move relative to the second base 13 along the direction of the optical axis S of the lens 13 to achieve focusing of the lens 13. After the focusing is completed, power is off, and the restoring structures restore the lens 13 together with the first base 11 to the initial position.

Compared with the related art, in this embodiment, the third memory alloy wire 20 and the fourth memory alloy wire 21 are energized to deform to cooperate with the restoring structures 20 in driving the first base 11 to move. That is, the lens 13 is driven to move along the direction of the optical axis S to achieve auto focusing of the lens 13. There is no need for a traditional driving method using an interaction between the voice coil and the magnetic steel, and there is no problem of magnetic field interference, and thus stability thereof is high. Moreover, such driving method is simple in structure and convenient in assembling, has no need for an additional Hall element, and has high usage reliability in a special environment.

Moreover, compared with the existing image stabilization structure using a magnet cooperating with an image stabilization coil, the third memory alloy wire 20 and the fourth memory alloy wire 21 used in this embodiment can significantly reduce a weight and a cost thereof. In addition, compared with the existing image stabilization structure using a magnet cooperating with an image stabilization coil, the third memory alloy wire 20 and the fourth memory alloy wire 21 used in this embodiment can pull the first base 11 to move as long as a small amount of current is applied to the third memory alloy wire 20 and the fourth memory alloy wire 21, thereby achieving an auto focusing effect while effectively reducing power consumption thereof.

For ease of description, the first side plate 112 and the second side plate 113 of the first base 11 are collectively referred to as a first side arm 11a, and the third side plate 192 and the fourth side plate 193 of the second base 19 are collectively referred to as second side arm 19a. In this case, the first base 11 includes: the first bottom plate 111, and the first side arms 11a extending from the first bottom plate 111 while being bent and respectively located at two sides of the lens 13. The second base 19 includes the second bottom plate 191, and the second side arms 19a extending from the second bottom plate 191 while being bent and respectively located outside the first side arm 11a. The first side arm 11a includes: a first plate body 101 opposite to the second side arm 19a, and a second plate body 102 extending from an end of the first plate body 101 facing away from the first bottom plate 112 while being bent and located above the second side arm 19a. One restoring structure 22 is provided at each of two sides of the lens 13. The restoring structure 22 includes: a magnet assembly 23 provided between the second side arm 19a and the second plate body 102, a guiding structure 24 provided between the first plate body 101 and the second side arm 19a, and an elastic member 25 provided between the first side arm 11a and the second side arm 19a in the direction parallel to the optical axis S. In this embodiment, the elastic member 25 cooperates with the magnet assembly 23 to pull the deviated first base 11 in such a manner that the first base 11 is restored to the initial position under guiding of the guiding structure 24. Compared with a traditional method using a voice coil motor, the design with the restoring structure 22 is simple in structure. Moreover, the magnet assembly 23 is provided between the second side arm 19a and the second plate body 102, the guiding structure 24 is provided between the first plate body 101 and the second side arm 19a, and the elastic member 25 is provided between the first side arm 11a and the second side arm 19a in the direction parallel to the optical axis S. In this way, an overall structure formed by the restoring structure 22, the first base 11, the second base 19 and the lens 13 is very compact, so that an overall dimension of the lens assembly 100 can be made small, thereby achieving a miniaturization design.

As an improvement of this embodiment, a projection of the magnet assembly 23 in the direction perpendicular to the optical axis S is located on the elastic member 25.

As an improvement of this embodiment, the guiding structure 24 is located between the elastic member 25 and the at least one magnet assembly 23 in the direction perpendicular to the optical axis S of the lens 13.

As an improvement of this embodiment, the first side arm 11a further includes a third plate body 103 extending from an end of the first plate body 101 in the direction of the optical axis S while being bent in a direction facing away from an object side of the lens 13; and the first plate body 101, the second plate body 102 and the third plate body 103 form a concave part 26 for receiving the second side arm 19a.

As an improvement of this embodiment, the second side arm 19a includes a first connecting portion 104 connected to the second bottom plate 191, a second connecting portion 105 spaced apart from and opposite to the first connecting portion 104, and a third connecting portion 106 connected to a side of the first connecting portion 104 facing away from the third plate body 103 and a side of the second connecting portion 105 facing away from the third plate body 103. The elastic member 25 includes an end connected to the third plate body 103, and another end connected to the third connecting portion 106.

As an improvement of this embodiment, two magnet assemblies 23 spaced apart from each other are provided between the second side arm 19a and the second plate body 102.

As an improvement of this embodiment, each magnet assembly 23 includes: a first magnet 231 located at a side of the second side arm 19a facing towards the second plate body 102, and a second magnet 232 directly opposite to the first magnet 231 and provided at a side of the second plate body 102 facing towards the second side arm 19a. When the lens 13 is at the initial position, the first magnet 231 is opposite to the second magnet 232, and when the third memory alloy wire 20 and the fourth memory alloy wire 21 pull the first base 11 to move relative to the second base 19, the first magnet 231 is misaligned with the second magnet 232. After the third memory alloy wire 20 and the fourth memory alloy wire 21 are powered off, the first magnet 231 and the second magnet 232 restore the first base 11 and the lens 13 to the initial position under a magnetic force and an elastic force of the elastic member 25.

As an improvement of this embodiment, a first receiving groove 195 is provided at a side of the second side arm 19a facing towards the second plate body 102, and the first magnet 231 is embedded into the first receiving groove 195. A second receiving groove 107 is provided at a side of the second plate body 102 facing towards the second side arm 19a, and the second magnet 232 is embedded into the second receiving groove 107. By providing the first receiving groove 195 for receiving the first magnet 231 and providing the second receiving groove 107 for receiving the second magnet 232, a space of the lens assembly 100 can be reasonably utilized, leads to the more compact structure therefor.

As an improvement of this embodiment, two guiding structures 24 spaced apart from each other are provided between the second side arm 19a and the first plate body 101. In an example, each guiding structure 24 includes: a first guiding groove 241 formed by recessing from a surface of the first plate body 101 facing towards the second side arm 19a in the direction of the optical axis S, a bearing portion 242 provided at a surface of the second side arm 19a facing towards the first plate body 101 and configured to form a guiding channel in cooperation with the first guiding groove 241, and a ball 243 provided between the first guiding groove 241 and the bearing portion 242. By providing the guiding structure 24 at each of two sides of the magnet assembly 23, a frictional force generated when the second side arm 19a and the first plate body 101 are sliding relative to each other can be reduced, so that deviation and restoration of the first base 11 can be more sensitive.

As an improvement of this embodiment, a projection of the elastic member 25 located at a same side as the third memory alloy wire 20 along the direction perpendicular to the optical axis S is located on the third memory alloy wire 20; and a projection of the elastic member 25 located at a same side as the fourth memory alloy wire 21 along the direction perpendicular to the optical axis S is located on the fourth memory alloy wire 21.

As an improvement of this embodiment, the lens assembly 100 further includes two third connecting terminals 27 and two fourth connecting terminals 28. The two third connecting terminals 27 are mounted to the first side arm 11a and the second side arm 19a, respectively. Two ends of the third memory alloy wire 20 are connected to the two third connecting terminals 27, respectively. The two fourth connecting terminals 28 are mounted to the first side arm 11a and the second side arm 19a, respectively. Two ends of the fourth memory alloy wire 21 are connected to the two fourth connecting terminals 28, respectively.

The above description merely illustrates some embodiments of the present invention. It should be noted that those skilled in the art can make improvements without departing from a creative concept of the present invention, but all these improvements shall fall into a scope of the present invention.

What is claimed is:

1. An auto focusing lens assembly, comprising:
a lens;
a first base;
a second base; and
a pair of restoring structures,
wherein the lens is located in the first base, and the first base is mounted to the second base and slidable in a direction parallel to an optical axis of the lens; the first base comprises: a first bottom plate, and a first side arm extending from the first bottom plate while being bent and respectively located at two sides of the lens; the second base comprises a second bottom plate, and a second side arm extending from the second bottom plate while being bent and respectively located outside the first side arm; the first side arm comprises: a first plate body opposite to the second side arm, and a second plate body extending from an end of the first plate body facing away from the first bottom plate while being bent and located above the second side arm; one of the pair of restoring structures is provided at one of the two sides of the lens, and the other one of the pair of restoring structures is provided at the other one of the two sides of the lens; each restoring structure of the pair of restoring structures comprises: at least one magnet assembly provided between the second side arm and the second plate body, at least one guiding structure provided between the first plate body and the second side arm, and an elastic member provided between the first side arm and the second side arm in the direction parallel to the optical axis.

2. The auto focusing lens assembly as described in claim 1, wherein a projection of the at least one magnet assembly in a direction perpendicular to the optical axis is located on the elastic member.

3. The auto focusing lens assembly as described in claim 1, wherein the at least one guiding structure is located between the elastic member and the at least one magnet assembly in a direction perpendicular to the optical axis of the lens.

4. The auto focusing lens assembly as described in claim 1, wherein the first side arm further comprises a third plate body extending from an end of the first plate body facing away from an object side of the lens in the direction of the optical axis; and the first plate body, the second plate body and the third plate body form a recess for receiving the second side arm.

5. The auto focusing lens assembly as described in claim 4, wherein the second side arm comprises a first connecting portion connected to the second bottom plate, a second connecting portion spaced apart from and opposite to the first connecting portion, and a third connecting portion connected to a side of the first connecting portion facing away from the third plate body and a side of the second connecting portion facing away from the third plate body; and the elastic member comprises an end connected to the third plate body, and another end connected to the third connecting portion.

6. The auto focusing lens assembly as described in claim 1, wherein the at least one magnet assembly comprises two magnet assemblies provided between the second side arm and the second plate body, and the two magnet assemblies are spaced apart from each other.

7. The auto focusing lens assembly as described in claim 6, wherein each of the two magnet assemblies comprises: a first magnet located at a side of the second side arm facing towards the second plate body, and a second magnet directly opposite to the first magnet and provided at a side of the second plate body facing towards the second side arm.

8. The auto focusing lens assembly as described in claim 7, wherein a first recess is provided at the side of the second side arm facing towards the second plate body, and the first magnet is embedded into the first recess; and a second recess is provided at the side of the second plate body facing towards the second side arm, and the second magnet is embedded into the second recess.

9. The auto focusing lens assembly as described in claim 1, wherein the at least one guiding structure comprises two guiding structures provided between the second side arm and the first plate body, and the two guiding structures are spaced apart from each other.

10. The auto focusing lens assembly as described in claim 9, wherein each of the two guiding structures comprises: a first guiding groove formed by recessing from a surface of the first plate body facing towards the second side arm in the direction of the optical axis, a bearing portion provided at a surface of the second side arm facing towards the first plate body and configured to form a guiding channel in cooperation with the first guiding groove, and a ball provided between the first guiding groove and the bearing portion.

11. The auto focusing lens assembly as described in claim 1, further comprising a memory alloy wire for auto focusing of the lens, wherein the memory alloy wire comprises an end fixed to the first base, and another end fixed to the second base; and a projection of the elastic member in a direction perpendicular to the optical axis is located on the memory alloy line.
